(19) United States
(12) Patent Application Publication
(10) Pub. No.: US 2025/0306408 A1
(43) Pub. Date: Oct. 2, 2025

(54) OPTICAL DEVICE, OPTICAL TRANSMISSION DEVICE, AND OPTICAL RECEPTION DEVICE

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 19/048,468

(22) Filed: Feb. 7, 2025

(30) Foreign Application Priority Data
Apr. 1, 2024 (JP) 2024-059129

(51) Int. Cl. G02F 1/025; G02F 1/015

(52) U.S. Cl. CPC G02F 1/025; G02F 1/0155

(57) ABSTRACT

An optical device includes a rib optical waveguide including N parallel waveguides connected to outputs of a split coupler of 1 input×N outputs, and a first electrode and a second electrode that are connected to the rib optical waveguide. The rib optical waveguide includes a non-conductive slab region formed between the waveguides, a P-doped region and an N-doped region. The P-doped region is formed in a first slab region outside one of outermost waveguides of the N waveguides and is connected to the first electrode. The N-doped region is formed in a second slab region outside the other one of the outermost waveguides of the N waveguides and is connected to the second electrode.

### CROSS-REFERENCE TO RELATED APPLICATION

This application is based upon and claims the benefit of priority of the prior Japanese Patent Application No. 2024-059129, filed on Apr. 1, 2024, the entire contents of which are incorporated herein by reference.

### FIELD

The embodiments discussed herein are related to an optical device, an optical transmission device, and an optical reception device.

### BACKGROUND

Demand for optical fiber communication is increasing with the recent increase in communication capacity. Optical devices, represented by silicon photonics, have thus been developed actively. Known examples of such optical devices include optical attenuators, such as variable optical attenuators (VOAs), which attenuate intensity of signal light guided through optical waveguides according to electric signals.

FIG. 13 is a schematic plan view of an example of an optical device 100. FIG. 14 is a schematic sectional view taken on a line A-A illustrated in FIG. 13. A VOA 110, which is the optical device 100, has a Si substrate 121, a rib optical waveguide 102 formed on the Si substrate 121, and electrodes 103 connected to the rib optical waveguide 102 at both sides. The VOA 110 also has a cladding layer 122 formed on the Si substrate 121 and surrounding peripheries of the rib optical waveguide 102 and two electrodes 103.

The rib optical waveguide 102 has, for example, a waveguide 102A forming a Si core, and a first slab region 102D and a second slab region 102E on both sides of the waveguide 102A. The rib optical waveguide 102 has an optical input portion 102B and an optical output portion 102C. The optical input portion 102B is an input stage of the rib optical waveguide 102, the input stage being where signal light is input to the waveguide 102A. The optical output portion 102C is an output stage of the rib optical waveguide 102, the output stage being where the signal light is output from the waveguide 102A. A P-doped region 102F that has been P-doped is formed in the first slab region 102D and an N-doped region 102G that has been N-doped is formed in the second slab region 102E. The waveguide 102A, a part of the first slab region 102D, and a part of the second slab region 102E are undoped regions. The P-doped region 102F, the undoped regions, and the N-doped region 102G that are in the rib optical waveguide 102, have a PIN diode structure.

The electrodes 103 have a first electrode 103A electrically connected to the P-doped region 102F and a second electrode 103B electrically connected to the N-doped region 102G. The first electrode 103A is a signal electrode connected to a power supply pad 104 for application of voltage and the second electrode 103B is a ground electrode connected to a grounding pad 105.

In the optical device 100, the power supply pad 104 is positioned near the center of the VOA 110 and power is supplied from the power supply pad 104 to the first electrode 103A via a power supply via 104A. In the optical device 100, the grounding pad 105 is positioned near the center of the VOA 110 and grounding is achieved from the second electrode 103B to the grounding pad 105 via a grounding via 105A.

In a case where positive voltage is applied from the power supply pad 104 to the first electrode 103A, electric current flows from the first electrode 103A to the second electrode 103B and the electric current will thus flow through the rib optical waveguide 102 arranged between the first electrode 103A and the second electrode 103B. As a result, intensity of signal light is attenuated by absorption of signal light guided through the rib optical waveguide 102 due to free carrier absorption of the electric current flowing through the rib optical waveguide 102.

Patent Literature 1: U.S. Patent Application Publication No. 2022/0326586

Patent Literature 2: Japanese Laid-open Patent Publication No. 2023-075026

Patent Literature 1: Japanese Laid-open Patent Publication No. 2019-191246

However, when intensity of signal light input into the rib optical waveguide 102 increases in the optical device 100, light absorption by the Si substrate 121 increases, and propagation loss in the rib optical waveguide 102 thus increases. What is more, when the intensity of the signal light input into the rib optical waveguide 102 increases, the optical device 100 may break down due to the light absorption by the Si substrate 121.

### SUMMARY

According to an aspect of an embodiment, an optical device includes a rib optical waveguide including N parallel waveguides connected to outputs of a split coupler of 1 input×N outputs, and a first electrode and a second electrode that are connected to the rib optical waveguide. The rib optical waveguide includes a non-conductive slab region formed between the waveguides, a P-doped region and an N-doped region. The P-doped region is formed in a first slab region outside one of outermost waveguides of the N waveguides and is connected to the first electrode. The N-doped region is formed in a second slab region outside the other one of the outermost waveguides of the N waveguides and is connected to the second electrode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view of an example of an optical device according to a first embodiment;

FIG. 2 is a schematic sectional view taken on a line A-A illustrated in FIG. 1;

FIG. 3 is a schematic plan view of an example of an optical device according to a second embodiment;

FIG. 4 is a schematic sectional view taken on a line A-A illustrated in FIG. 3;

FIG. 5 is a schematic plan view of an example of an optical device according to a third embodiment;

FIG. 6 is a schematic sectional view taken on a line A-A illustrated in FIG. 5;

FIG. 7 is a schematic sectional view taken on a line B-B illustrated in FIG. 5;

FIG. 8 is a schematic plan view of an example of an optical device according to a fourth embodiment;

FIG. 9 is a schematic sectional view taken on a line A-A illustrated in FIG. 8;

FIG. 10 is a diagram illustrating an example of an optical transceiver that has adopted an optical device, according to an embodiment;

FIG. 11 is a schematic plan view of an example of an optical device according to a comparative example;

FIG. 12 is a schematic sectional view taken on a line A-A illustrated in FIG. 11;

FIG. 13 is a schematic plan view of an example of an optical device; and

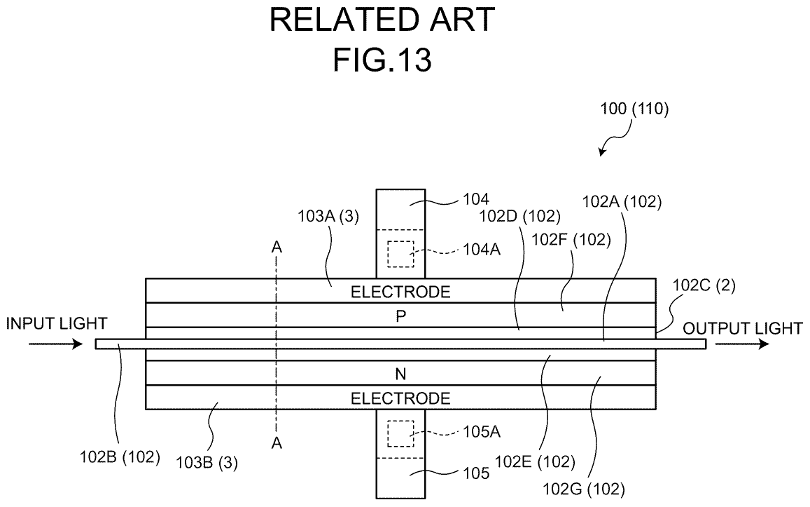

FIG. 14 is a schematic sectional view taken on a line A-A illustrated in FIG. 13.

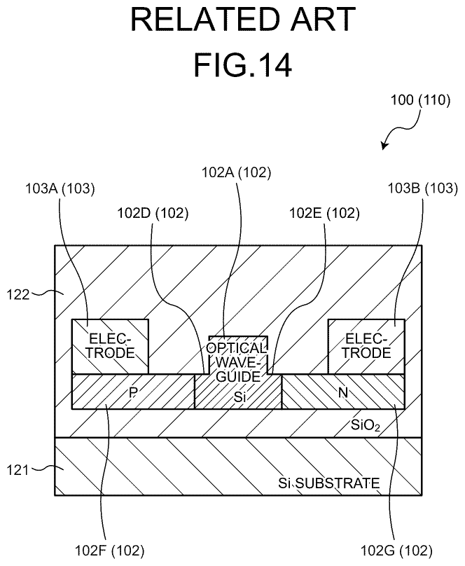

### DESCRIPTION OF EMBODIMENTS

### Comparative Example

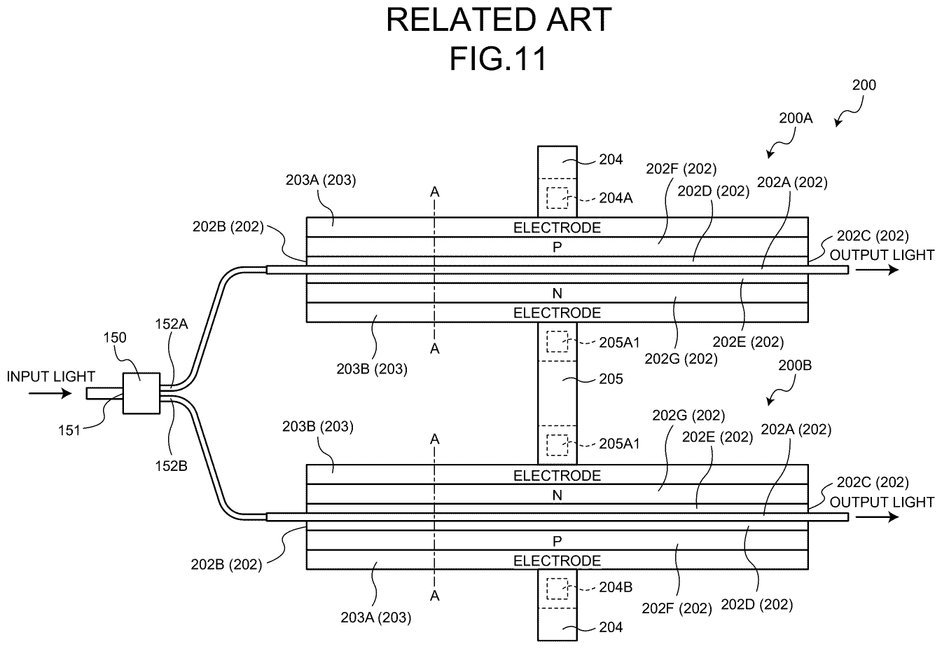

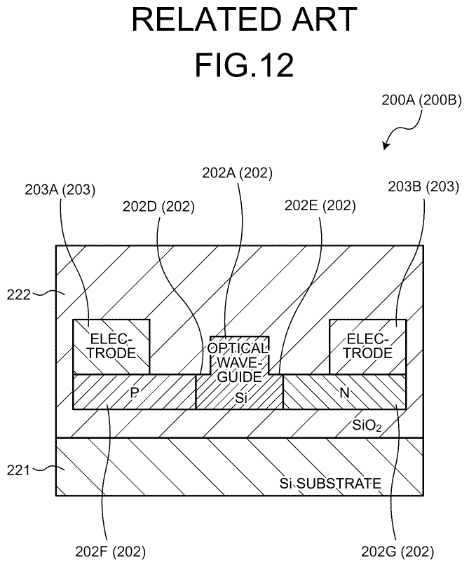

Using a VOA according to a comparative example may be considered as a method enabling reduction of propagation loss in the rib optical waveguide 102 even when the intensity of signal light input to the rib optical waveguide 102 in the conventional optical device 100 is increased, the VOA enabling the intensity of signal light input to a rib optical waveguide 102 to be halved. FIG. 11 is a schematic plan view of an example of an optical device 200 according to the comparative example and FIG. 12 is a schematic sectional view taken on a line A-A illustrated in FIG. 11.

The optical device 200 illustrated in FIG. 11 has a split coupler 150 of 1×2, a first VOA 200A connected to one of split outputs of the split coupler 150, and a second VOA 200B connected to the other split output of the split coupler 150. The split coupler 150 is a 1×2 coupler and has an input portion 151 where signal light is input, and a first output portion 152A and a second output portion 152B where the signal light input from the input portion 151 is split and output at a split ratio of 1:2.

The first VOA 200A has a Si substrate 221, a rib optical waveguide 202 formed on the Si substrate 221, and electrodes 203 connected to the rib optical waveguide 202 at both sides. The first VOA 200A also has a cladding layer 222 formed on the Si substrate 221 and surrounding peripheries of the rib optical waveguide 202 and two electrodes 203.

The rib optical waveguide 202 has, for example, a waveguide 202A forming a Si core, and a first slab region 202D and a second slab region 202E on both sides of the waveguide 202A. The rib optical waveguide 202 has an optical input portion 202B and an optical output portion 202C. The optical input portion 202B is an input stage of the rib optical waveguide 202, the input stage being where signal light is input to the waveguide 202A. The optical output portion 202C is an output stage of the rib optical waveguide 202, the output stage being where the signal light is output from the waveguide 202A. A P-doped region 202F that has been P-doped is formed in the first slab region 202D and an N-doped region 202G that has been N-doped is formed in the second slab region 202E. The waveguide 202A, a part of the first slab region 202D, and a part of the second slab region 202E are undoped regions. The P-doped region 202F, the undoped regions, and the N-doped region 202G that are in the rib optical waveguide 202 have a PIN diode structure.

The electrodes 203 have a first electrode 203A electrically connected to the P-doped region 202F and a second electrode 203B electrically connected to the N-doped region 202G. The first electrode 203A is a signal electrode connected to a power supply pad 204 for application of voltage and the second electrode 203B is a ground electrode connected to a grounding pad 205.

In the first VOA 200A, the power supply pad 204 is positioned near the center of the first VOA 200A and power is supplied from the power supply pad 204 to the first electrode 203A via a power supply via 204A. In the first VOA 200A, the grounding pad 205 is positioned near the center of the first VOA 200A and grounding is achieved from the second electrode 203B to the grounding pad 205 via a grounding via 205A1.

The second VOA 200B has the same configuration as the first VOA 200A and any redundant description of the configuration and operation thereof will thus be omitted by assignment of the same reference signs. The grounding pad 205 of the first VOA 200A and a grounding pad 205 of the second VOA 200B are connected to each other.

The split coupler 150 splits and outputs signal light input thereto, at the split ratio of 1:2, inputs signal light split and output to the first output portion 152A to the first VOA 200A and inputs signal light split and output to the second output portion 152B to the second VOA 200B.

In a case where positive voltage is applied from the power supply pad 204 to the first electrode 203A in the first VOA 200A, electric current flows from the first electrode 203A to the second electrode 203B. The electric current will then flow through the rib optical waveguide 202 arranged between the first electrode 203A and the second electrode 203B. As a result, intensity of signal light is attenuated by absorption of signal light guided through the rib optical waveguide 202 due to free carrier absorption of the electric current flowing through the rib optical waveguide 202 of a first VOA 205A.

In a case where positive voltage is applied from the power supply pad 204 to a first electrode 203A in the second VOA 200B via a power supply via 204B, electric current flows from the first electrode 203A to a second electrode 203B. The electric current will then flow through a rib optical waveguide 202 arranged between the first electrode 203A and the second electrode 203B. As a result, intensity of signal light is attenuated by absorption of signal light guided through the rib optical waveguide 202 due to free carrier absorption of the electric current flowing through the rib optical waveguide 202 of a second VOA 205B.

In the optical device 200 according to the comparative example, the split coupler 150 splits signal light, and power of signal light input to the rib optical waveguides 202 in the first VOA 200A and second VOA 200B is able to be reduced by half. As a result, absorption of light by the Si substrate 221 is lessened and propagation of signal light is enabled with reduced loss in the optical device 200.

However, because electric current is to be provided to the first electrodes 203A in the first VOA 200A and second VOA 200B in the optical device 200 according to the comparative example, consumption of electricity is doubled.

There is thus a demand for an optical device, such as a VOA, which enables minimization of propagation loss of light in an optical waveguide while minimizing consumption of electricity. Preferred embodiments of the present invention will be explained with reference to accompanying drawings. The following embodiments may be combined with one another as appropriate so long as no contradiction is caused by the combination.

### (a) First Embodiment

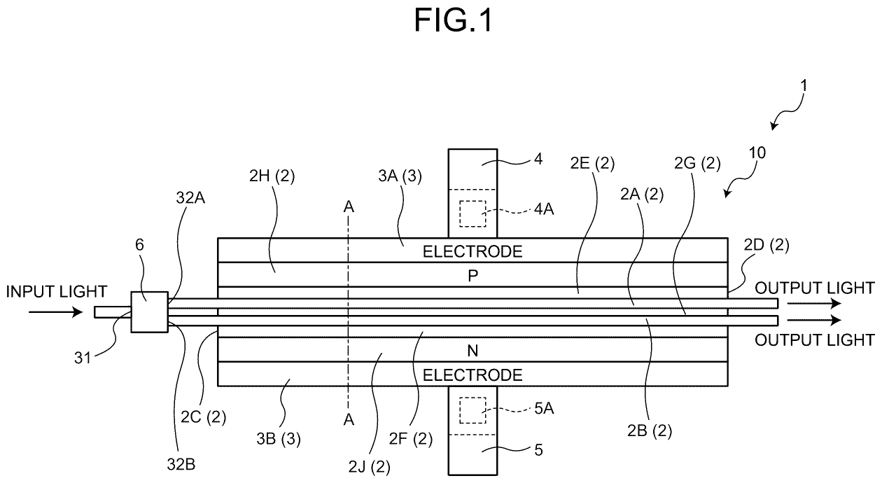

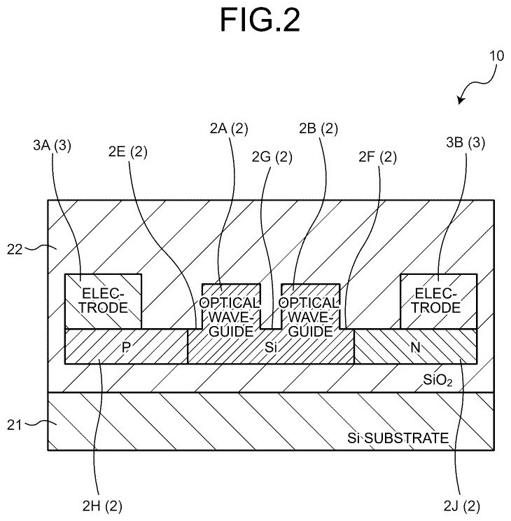

FIG. 1 is a schematic plan view of an example of an optical device 1 according to a first embodiment. FIG. 2 is a schematic sectional view taken on a line A-A illustrated in FIG. 1. The optical device 1 illustrated in FIG. 1 has a split coupler 6 and a VOA 10. The VOA 10 has a Si substrate 21, a rib optical waveguide 2 formed on the Si substrate 21, electrodes 3 electrically connected to the rib optical waveguide 2 at both sides, and a cladding layer 22 formed on the Si substrate 21 and surrounding peripheries of the rib optical waveguide 2 and two electrodes 3.

The split coupler 6 is a split coupler of 1 input×N outputs, for example, 1 input×2 outputs. The split coupler 6 has an input portion 31 where signal light is input, and a first output portion 32A and a second output portion 32B where signal light input from the input portion 31 is split and output at a split ratio of 1:2. The split coupler 6 outputs, for example, signal light of X polarization from the first output portion 32A and outputs, for example, signal light of Y polarization from the second output portion 32B, the signal light of X polarization and the signal light of Y polarization both being of the signal light input from the input portion 31.

The rib optical waveguide 2 is formed of, for example, Si. The rib optical waveguide 2 has two parallel waveguides connected to the outputs of the 1×2 split coupler 6. The two parallel waveguides have a first waveguide 2A connected to the first output portion 32A and a second waveguide 2B parallel to the first waveguide 2A and connected to the second output portion 32B. The first waveguide 2A and the second waveguide 2B have linear structures of the same width.

The rib optical waveguide 2 has an optical input portion 2C and an optical output portion 2D. The optical input portion 2C is an input stage of the rib optical waveguide 2, the input stage being where signal light is input to the first waveguide 2A and the second waveguide 2B. The optical output portion 2D is an output stage of the rib optical waveguide 2, the output stage being where signal light is output from the first waveguide 2A and the second waveguide 2B.

The rib optical waveguide 2 has a non-conductive slab region 2G formed between the first waveguide 2A and the second waveguide 2B, a first slab region 2E formed outside the first waveguide 2A, and a second slab region 2F formed outside the second waveguide 2B. A width of the non-conductive slab region 2G, that is, a width between the first waveguide 2A and the second waveguide 2B is a width that does not allow signal light guided through the first waveguide 2A and signal light guided through the second waveguide 2B to be coupled to each other.

The rib optical waveguide 2 has a P-doped region 2H formed in the first slab region 2E and an N-doped region 2J formed in the second slab region 2F. The P-doped region 2H is a region electrically connected to the first electrode 3A, the region resulting from P-doping of a portion outside the first slab region 2E. The N-doped region 2J is a region electrically connected to the second electrode 3B, the region resulting from N-doping of a portion outside the second slab region 2F.

The first waveguide 2A, the second waveguide 2B, a part of the first slab region 2E, a part of the second slab region 2F, and the non-conductive slab region 2G that are in the rib optical waveguide 2 are undoped regions. The P-doped region 2H, the undoped regions, and the N-doped region 2J that are in the rib optical waveguide 2 have a PIN diode structure, for example.

The electrodes 3 have the first electrode 3A electrically connected to the P-doped region 2H, and the second electrode 3B electrically connected to the N-doped region 2J. The first electrode 3A is a signal electrode connected to a power supply pad 4 for application of voltage. The first electrode 3A includes a material having electric resistance, for example, a metal, such as aluminum, or a semiconductor material, such as Si. The second electrode 3B is a ground electrode connected to a grounding pad 5. The second electrode 3B also includes a material having electric resistance, for example, a metal, such as aluminum, or a semiconductor material, such as Si or Ge.

The cladding layer 22 is formed of, for example, SiO₂. The power supply pad 4 is an electrode pad connected to the first electrode 3A. The grounding pad 5 is an electrode pad connected to the second electrode 3B.

In the optical device 1, the power supply pad 4 is positioned near the center of the VOA 10 and power is supplied from the power supply pad 4 to the first electrode 3A via a power supply via 4A. In the optical device 1, the grounding pad 5 is positioned near the center of the VOA 10 and grounding is achieved from the second electrode 3B to the grounding pad 5 via a grounding via 5A.

In a case where positive voltage is applied from the power supply pad 4 to the first electrode 3A, electric current flows from the first electrode 3A to the second electrode 3B. The electric current will then flow through the first waveguide 2A and the second waveguide 2B that are in the rib optical waveguide 2 and arranged between the first electrode 3A and the second electrode 3B. As a result, signal light guided through the first waveguide 2A and the second waveguide 2B is absorbed and intensity of the signal light is thereby attenuated, due to free carrier absorption of the electric current flowing through the parallel first waveguide 2A and second waveguide 2B in the rib optical waveguide 2. That is, even in a case where the intensity of signal light input into the rib optical waveguide 2 is increased, the split coupler 6 halves the intensity of signal light input to the first waveguide 2A and the second waveguide 2B. As a result, optical absorption by the Si substrate 21 is lessened and propagation loss in the rib optical waveguide 2 is able to be reduced.

The optical device 1 according to the first embodiment has: the rib optical waveguide 2 including the two parallel waveguides that are parallel to each other and are connected to the outputs of the split coupler 6 of 1 input×2 outputs; and the first electrode 3A and second electrode 3B that are connected to the rib optical waveguide 2. The rib optical waveguide 2 has the non-conductive slab region 2G formed between the first waveguide 2A and the second waveguide 2B. Furthermore, the rib optical waveguide 2 has the P-doped region 2H formed at the first slab region 2E and connected to the first electrode 3A, and the N-doped region 2J formed at the second slab region 2F and connected to the second electrode 3B. As a result, even in a case where the intensity of signal light input to the VOA 10 is increased, the split coupler 6 halves the intensity of signal light input to the first waveguide 2A and the second waveguide 2B, optical absorption by the Si substrate 21 is thereby lessened, and propagation loss in the rib optical waveguide 2 is thus able to be reduced. The rib optical waveguide 2 thus has high optical input tolerance. What is more, sharing of the electrodes 3 for application of voltage to the first waveguide 2A and the second waveguide 2B in the rib optical waveguide 2 enables a much larger decrease in consumption of electricity, as compared to the optical device 200 according to the comparative example.

The case where the first waveguide 2A and the second waveguide 2B have the same rib width has been described as an example with respect to the rib optical waveguide 2 of the optical device 1 according to the first embodiment, but without being limited to this example, a second embodiment will hereinafter be described as an embodiment related to their rib widths.

### (b) Second Embodiment

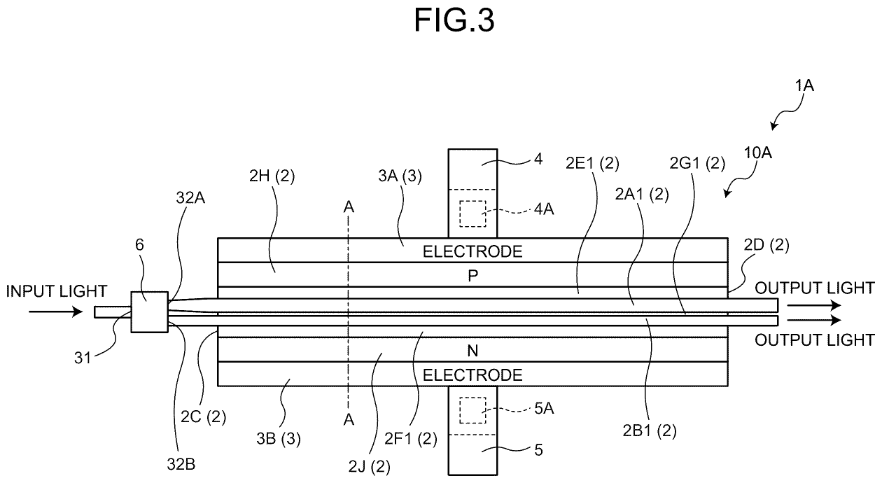

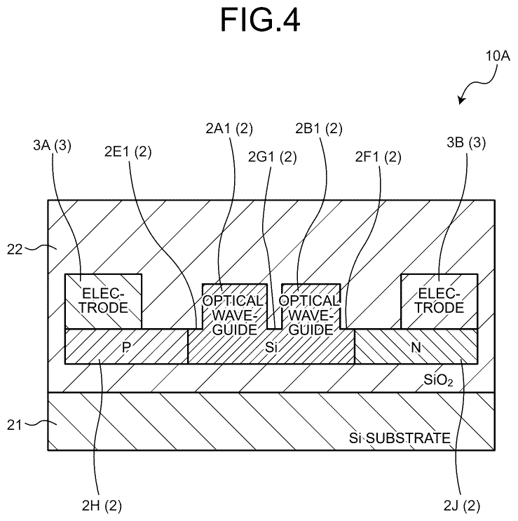

FIG. 3 is a schematic plan view of an example of an optical device 1A according to the second embodiment, and FIG. 4 is a schematic sectional view taken on a line A-A illustrated in FIG. 3. By assignment of the same reference signs to components that are the same as those of the optical device 1 according to the first embodiment, any redundant description of the same components and operation thereof will be omitted.

The optical device 1A according to the second embodiment is different from the optical device 1 according to the first embodiment in that a first waveguide 2A1 and a second waveguide 2B1 that are in a rib optical waveguide 2 of the optical device 1A have rib widths different from each other. The rib width of the first waveguide 2A1 is wider than the rib width of the second waveguide 2B1. A first slab region 2E1 of the first waveguide 2A1 has the same width as a second slab region 2F1 of the second waveguide 2B1. The rib optical waveguide 2 has a non-conductive slab region 2G1 formed between the first waveguide 2A1 and the second waveguide 2B1.

Coupling of light may occur between the first waveguide 2A and the second waveguide 2B in the case of the first embodiment where the first waveguide 2A and the second waveguide 2B have the same rib width. The rib widths of the first waveguide 2A1 and the second waveguide 2B1 have thus been adjusted to be different from each other in this second embodiment. Adjusting the rib widths of the first waveguide 2A1 and the second waveguide 2B1 adjacent to each other prevents coupling of light between the first waveguide 2A1 and the second waveguide 2B1 adjacent to each other.

For example, decreasing the rib widths of waveguides weakens confinement of light in the waveguides and propagation loss is increased by absorption of light in the doped regions. Therefore, the rib widths are to be adjusted so that the propagation loss is not increased. Increasing the rib widths of waveguides enables multi-mode propagation in the waveguides and generates noise in the optical signal. Therefore, the rib widths are to be adjusted so that multimode propagation does not occur.

Therefore, in view of these adjustment points, the rib width of the first waveguide 2A1 has been made wider and the rib width of the second waveguide 2B1 has been made narrower. Accordingly, the difference between the rib widths of the first waveguide 2A1 and the second waveguide 2B1 generates a difference between effective refractive indices of the first waveguide 2A1 and the second waveguide 2B1 and thus prevents optical coupling between signal light guided through the first waveguide 2A1 and signal light guided through the second waveguide 2B1.

Because the rib width of the first waveguide 2A1 has been made wider and the rib width of the second waveguide 2B1 has been made narrower in the optical device 1A according to the second embodiment, optical coupling between signal light guided through the first waveguide 2A1 and signal light guided through the second waveguide 2B1 is able to be reduced.

Even in a case where the intensity of signal light input to a VOA 10A is increased in the optical device 1A, a split coupler 6 thereof halves the intensity of signal light input to the first waveguide 2A and the second waveguide 2B. As a result, optical absorption by a Si substrate 21 thereof is lessened and propagation loss in the rib optical waveguide 2 is able to be reduced. What is more, electrodes 3 for application of voltage to the first waveguide 2A and the second waveguide 2B in the rib optical waveguide 2 are shared. As a result, consumption of electricity is able to be reduced largely as compared to the optical device 200 according to the comparative example.

The case where the first waveguide 2A1 and the second waveguide 2B1 of the rib optical waveguide 2 in the optical device 1A according to the second embodiment have rib widths different from each other has been described as an example. For example, in a case where the rib width of the first waveguide 2A1 is made wider, optical confinement in the first waveguide 2A1 is increased and the extinction property is improved, and in a case where the rib width of the second waveguide 2B1 is made narrower, optical confinement in the second waveguide 2B1 is decreased and the extinction property is reduced. Therefore, the first waveguide 2A1 and the second waveguide 2B1 may have extinction properties different from each other. A third embodiment described hereinafter is thus an embodiment addressing this situation.

### (c) Third Embodiment

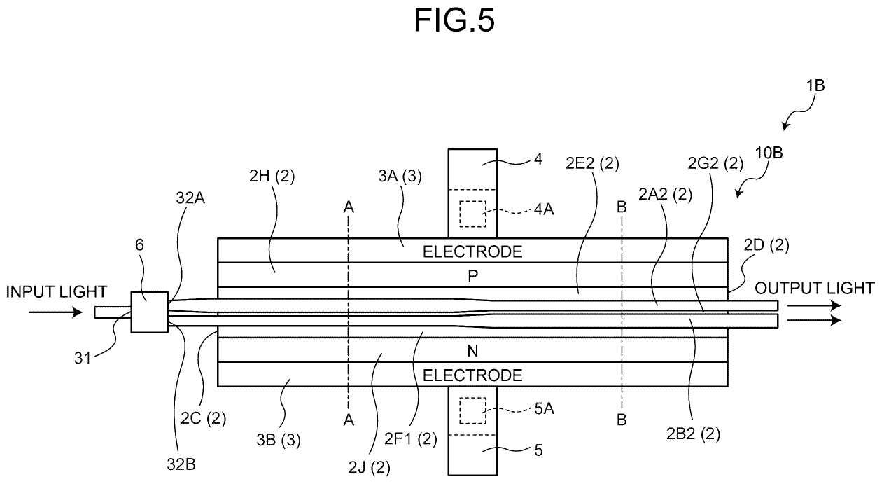

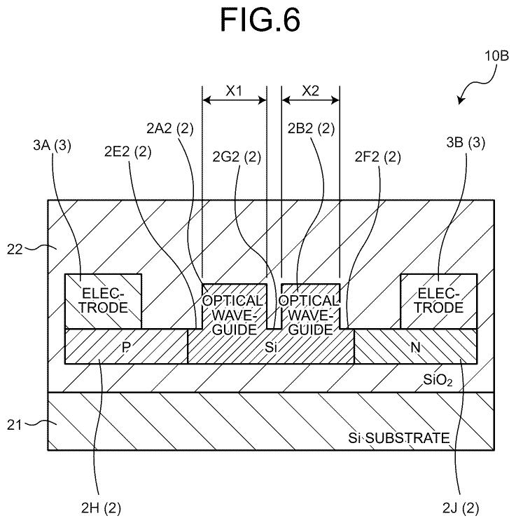

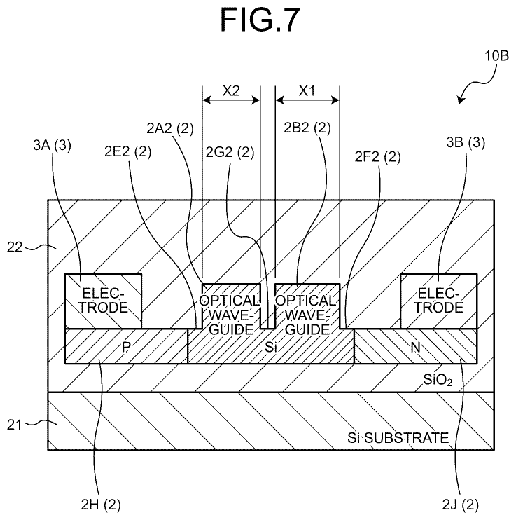

FIG. 5 is a schematic plan view of an example of an optical device 1B according to the third embodiment, FIG. 6 is a schematic sectional view taken on a line A-A illustrated in FIG. 5, and FIG. 7 is a schematic sectional view taken on a line B-B illustrated in FIG. 5. By assignment of the same reference signs to components that are the same as those of the optical device 1 according to the first embodiment, any redundant description of the same components and operation thereof will be omitted.

The optical device 1B according to the third embodiment is different from the optical device 1 according to the first embodiment in that the optical device 1B is configured such that a first waveguide 2A2 thereof changes in rib width between an optical input portion 2C and an optical output portion 2D thereof and a second waveguide 2B2 thereof changes in rib width between the optical input portion 2C and the optical output portion 2D. Furthermore, the first waveguide 2A2 is configured to be in point symmetry with the second waveguide 2B2.

The first waveguide 2A2 in the optical device 1B has a first rib width X1 that is wider from the optical input portion 2C to an intermediate portion, and a second rib width X2 that is narrower from the intermediate portion to the optical output portion 2D. Furthermore, the intermediate portion of the first waveguide 2A2 has a tapered rib width that gradually changes from the first rib width X1 to the second rib width X2.

The second waveguide 2B2 in the optical device 1B has the second rib width X2 that is narrower from the optical input portion 2C to an intermediate portion and the first rib width X1 that is wider from the intermediate portion to the optical output portion 2D. Furthermore, the intermediate portion of the second waveguide 2B2 has a tapered rib width that gradually changes from the second rib width X2 to the first rib width X1. That is, the first waveguide 2A2 and the second waveguide 2B2 are configured to be in point symmetry with each other.

A first slab region 2E2 of the first waveguide 2A2 changes in width according to the rib width of the first waveguide 2A2. A second slab region 2F2 of the second waveguide 2B2 changes in width according to the rib width of the second waveguide 2B2. The rib optical waveguide 2 has a non-conductive slab region 2G2 formed between the first waveguide 2A2 and the second waveguide 2B2.

The rib widths of the first waveguide 2A2 and the second waveguide 2B2 are different from each other between the optical input portion 2C and the optical output portion 2D but the first waveguide 2A2 and the second waveguide 2B2 are configured to be in point symmetry with each other. As a result, extinction ratios of the first waveguide 2A2 and the second waveguide 2B2 are able to be made the same at the optical output portion 2D.

The optical device 1B according to the third embodiment is configured such that the first waveguide 2A2 changes in rib width between the optical input portion 2C and the optical output portion 2D and the second waveguide 2B2 changes in rib width between the optical input portion 2C and the optical output portion 2D. In the optical device 1B, the first waveguide 2A2 is configured to be in point symmetry with the second waveguide 2B2. As a result, extinction ratios of the first waveguide 2A2 and the second waveguide 2B2 are able to be made the same at the optical output portion 2D.

What is more, because the rib width of the first waveguide 2A2 and the rib width of the second waveguide 2B2 are different from each other in the optical device 1B, optical coupling between signal light guided through the first waveguide 2A2 and signal light guided through the second waveguide 2B2 is able to be reduced.

Even in a case where the intensity of signal light input to a VOA 10B is increased in the optical device 1B, a split coupler 6 halves the intensity of signal light input to the first waveguide 2A2 and the second waveguide 2B2. As a result, optical absorption by a Si substrate 21 thereof is lessened and propagation loss in the rib optical waveguide 2 is able to be reduced. What is more, electrodes 3 for application of voltage to the first waveguide 2A2 and the second waveguide 2B2 in the rib optical waveguide 2 are shared. As a result, consumption of electricity is able to be reduced largely as compared to the optical device 200 according to the comparative example.

The case where the split coupler 6 of 1 input×2 outputs is used and the parallel waveguides have two waveguides has been described as an example with respect to the optical device 1 according to the first embodiment, but in a case where a split coupler 6 of 1 input×N outputs is used, parallel waveguides have N waveguides. A fourth embodiment described hereinafter is thus an embodiment in a case where a split coupler 6A of 1 input×3 outputs is used.

### (d) Fourth Embodiment

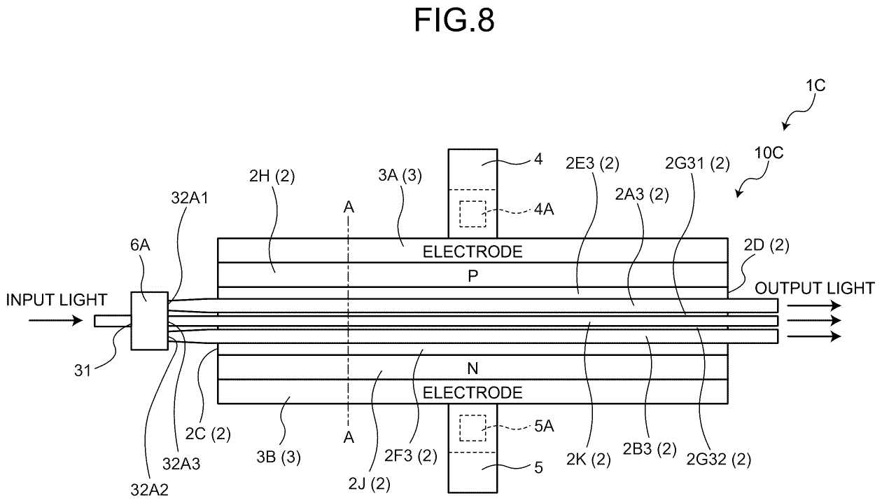

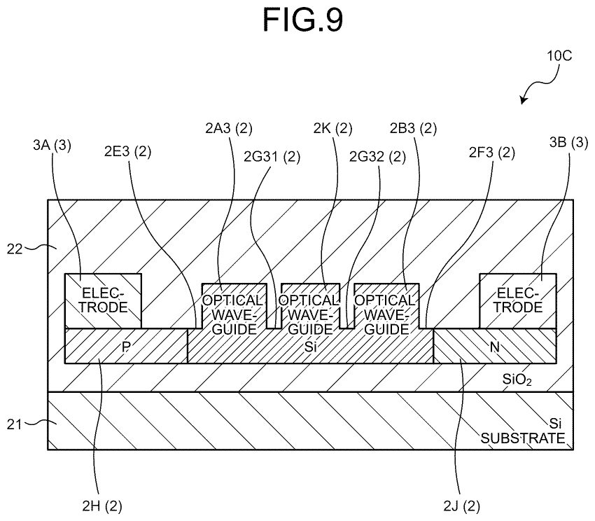

FIG. 8 is a schematic plan view of an example of an optical device 1C according to the fourth embodiment, and FIG. 9 is a schematic sectional view taken on a line A-A illustrated in FIG. 8. By assignment of the same reference signs to components that are the same as those of the optical device 1 according to the first embodiment, any redundant description of the same components and operation thereof will be omitted. The optical device 1C according to the fourth embodiment is different from the optical device 1 according to the first embodiment in that the split coupler 6A of 1 input×3 outputs is used and parallel waveguides have three waveguides, in the optical device 1C.

The optical device 1C has the split coupler 6A and a VOA 10C. The split coupler 6A is a split coupler of 1 input×3 outputs. The split coupler 6A has an input portion 31, a first output portion 32A1, a second output portion 32A2, and a third output portion 32A3.

The parallel waveguides in a rib optical waveguide 2 in the VOA 10C have a first waveguide 2A3 connected to the first output portion 32A1, a second waveguide 2B3 connected to the second output portion 32A2, and a third waveguide 2K connected to the third output portion 32A3. The first waveguide 2A3 has the same rib width as the second waveguide 2B3. The third waveguide 2K has a rib width narrower than that of the first waveguide 2A3.

The rib optical waveguide 2 has a non-conductive slab region 2G31 formed between the first waveguide 2A3 and the third waveguide 2K, and a first slab region 2E3 formed outside the first waveguide 2A3. The rib optical waveguide 2 has a non-conductive slab region 2G32 formed between the second waveguide 2B3 and the third waveguide 2K, and a second slab region 2F3 formed outside the second waveguide 2B3.

The non-conductive slab region 2G31 has a width that is a width between the first waveguide 2A3 and the third waveguide 2K and that does not allow signal light guided through the first waveguide 2A3 and signal light guided through the third waveguide 2K to be coupled to each other. The non-conductive slab region 2G32 has a width that is a width between the second waveguide 2B3 and the third waveguide 2K and that does not allow signal light guided through the second waveguide 2B3 and signal light guided through the third waveguide 2K to be coupled to each other.

The rib optical waveguide 2 has a P-doped region 2H formed in the first slab region 2E3 and an N-doped region 2J formed in the second slab region 2F3. The P-doped region 2H is a region electrically connected to a first electrode 3A, the region resulting from P-doping of a portion outside the first slab region 2E3. The N-doped region 2J is a region electrically connected to a second electrode 3B, the region resulting from N-doping of a portion outside the second slab region 2F3.

In the rib optical waveguide 2, the first waveguide 2A3, the third waveguide 2K, the second waveguide 2B3, a part of the first slab region 2E3, a part of the second slab region 2F3, the non-conductive slab region 2G31, and the non-conductive slab region 2G32 are undoped regions. The P-doped region 2H, the undoped regions, and the N-doped region 2J that are in the rib optical waveguide 2 have a PIN diode structure, for example.

In a case where positive voltage is applied from a power supply pad 4 to the first electrode 3A, electric current flows from the first electrode 3A to the second electrode 3B. The electric current will then flow through the first waveguide 2A3, the third waveguide 2K, and the second waveguide 2B3 that are in the rib optical waveguide 2 and are arranged between the first electrode 3A and the second electrode 3B. As a result, signal light guided through the first waveguide 2A3, the third waveguide 2K, and the second waveguide 2B3 is absorbed due to free carrier absorption of the electric current flowing through the parallel first waveguide 2A3, the third waveguide 2K, and the second waveguide 2B3 in the rib optical waveguide 2. Intensity of the signal light is thereby attenuated.

That is, even in a case where the intensity of signal light input into the rib optical waveguide 2 is increased, the split coupler 6A halves the intensity of signal light input to the first waveguide 2A3, the third waveguide 2K, and the second waveguide 2B3. As a result, optical absorption by a Si substrate 21 thereof is lessened and propagation loss in the rib optical waveguide 2 is able to be reduced.

The optical device 1C according to the fourth embodiment has the rib optical waveguide 2 including the three parallel waveguides that are parallel to one another and connected to the outputs of the split coupler 6A of 1 input×3 outputs. As a result, even in a case where the intensity of signal light input to the VOA 10C is increased, the intensity of signal light input to the first waveguide 2A3, the second waveguide 2B3, and the third waveguide 2K becomes ⅓ at the split coupler 6A. Optical absorption by the Si substrate 21 is then lessened and propagation loss in the rib optical waveguide 2 is thus able to be reduced. What is more, sharing of the electrodes 3 for application of voltage to the first waveguide 2A3, the third waveguide 2K, and the second waveguide 2B3 that are in the rib optical waveguide 2 enables a much larger decrease in consumption of electricity, as compared to the optical device 200 according to the comparative example.

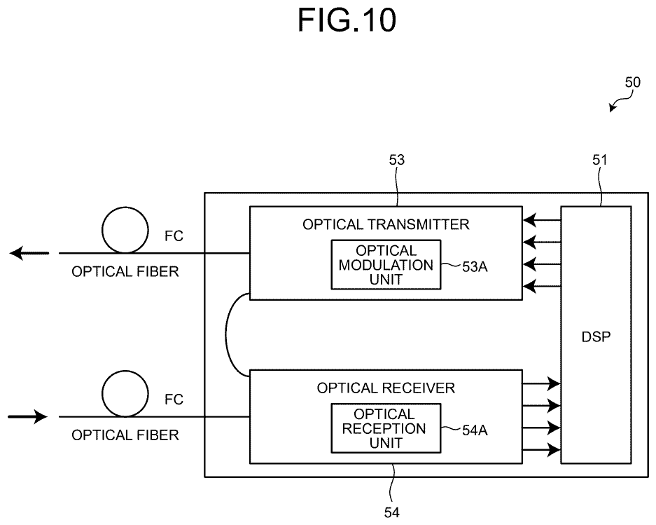

An optical transceiver 50 adopting the optical device 1 according to any one of the first to fourth embodiments will be described next. FIG. 10 is a diagram illustrating an example of the optical transceiver 50 adopting the optical device 1, according to an embodiment. The optical transceiver 50 illustrated in FIG. 10 is connected to an output optical fiber FC and an input optical fiber FC. The optical transceiver 50 has a digital signal processor (DSP) 51, an optical transmitter 53, and an optical receiver 54. The DSP 51 is an electric component that executes digital signal processing. For example, the DSP 51 executes processing, such as encoding, of transmitted data, generates an electric signal including the transmitted data, and outputs the electric signal generated, to the optical transmitter 53. Furthermore, the DSP 51 obtains an electric signal including received data from the optical receiver 54, and obtains the received data by executing processing, such as decoding, of the electric signal obtained.

The optical transmitter 53 outputs, to the optical fiber FC, transmitted light obtained by modulation of light supplied to the optical transmitter 53, the modulation using an electric signal output from the DSP 51. The optical transmitter 53 has an optical modulation unit 53A that generates transmitted light by modulating light supplied to the optical modulation unit 53A, using an electric signal input to an optical modulator when the light propagates through a waveguide.

The optical receiver 54 has an optical reception unit 54A that receives an optical signal from the optical fiber FC and demodulates received light by using light supplied to the optical reception unit 54A. The optical receiver 54 converts the received light demodulated, into an electric signal, and outputs the electric signal converted, to the DSP 51. Optical devices serving as waveguides for light have been built in the optical transmitter 53 and the optical receiver 54. For convenience of description, the case where

the optical transmitter 53 and the optical receiver 54 have been built in the optical transceiver 50 has been described as an example, but any one of the optical transmitter 53 and the optical receiver 54 may have been built in the optical transceiver 50. For example, the example may be modified as appropriate, and the optical device 1 may be applied to an optical transceiver 50 having the optical transmitter 53 built therein, or to an optical transceiver 50 having the optical receiver 54 built therein.

In this embodiment, the rib optical waveguide 2 may be: a planar lightwave circuit (PLC) having a core and cladding that are both SiO₂; an InP waveguide; or a GaAs waveguide. The core may be Si or Si₃N₄, lower cladding may be SiO₂, and upper cladding may be SiO₂ or air, for example.

The components of each part illustrated in the drawings may be not configured physically as illustrated in the drawings. That is, specific modes of separation and integration of the parts are not limited to those illustrated in the drawings, and all or part of the parts may be configured to be functionally or physically separated or integrated in any units according to various loads and use situations, for example.

All or any part of various processing functions implemented at each device may be executed on a central processing unit (CPU) (or a microcomputer, such as a microprocessing unit (MPU)) or a microcontroller unit (MCU)). All or any part of the various processing functions may be executed on a program analyzed and executed by a CPU (or a microcomputer, such as an MPU or MCU), or on hardware by wired logic.

According to one aspect, increase in propagation loss in a rib optical waveguide is able to be minimized.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device, comprising:
a rib optical waveguide including N parallel waveguides connected to outputs of a split coupler of 1 input×N outputs; and
a first electrode and a second electrode that are connected to the rib optical waveguide, wherein
the rib optical waveguide includes:
a non-conductive slab region formed between the waveguides;
a P-doped region that is formed in a first slab region outside one of outermost waveguides of the N waveguides and is connected to the first electrode; and
an N-doped region that is formed in a second slab region outside the other one of the outermost waveguides of the N waveguides and is connected to the second electrode.

2. The optical device according to claim 1, wherein
the rib optical waveguide includes two parallel waveguides connected to outputs of the split coupler of 1 input×2 outputs, and
one of the two waveguides has a waveguide width different from a waveguide width of the other one of the two waveguides.

3. The optical device according to claim 1, wherein
the rib optical waveguide includes two parallel waveguides connected to the outputs of the split coupler of 1 input×2 outputs,
one of the two waveguides changes in waveguide width between an input and an output,
the other one of the two waveguides changes in waveguide width between the input and the output, and
the one of the two waveguides is configured to be in point symmetry with the other one of the two waveguides.

4. The optical device according to claim 1, wherein
the P-doped region is a region that has been formed in the first slab region outside the one of the waveguides, the region resulting from P-doping of a portion outside the first slab region, and
the N-doped region is a region that has been formed in the second slab region outside the other one of the waveguides, the region resulting from N-doping of a portion outside the second slab region.

5. An optical transmission device, comprising:
an optical modulator that optically modulates light by using a transmitted signal and transmits transmitted light; and
an optical device that attenuates the light in the optical modulator, wherein
the optical device includes:
a rib optical waveguide including N parallel waveguides connected to outputs of a split coupler of 1 input×N outputs; and
a first electrode and a second electrode that are connected to the rib optical waveguide, and
the rib optical waveguide includes:
a non-conductive slab region formed between the waveguides;
a P doped region that is formed in a first slab region outside one of outermost waveguides of the N waveguides and is connected to the first electrode; and
an N-doped region that is formed in a second slab region outside the other one of the outermost waveguides of the N waveguides and is connected to the second electrode.

6. An optical reception device, comprising:
an optical receiver that receives a received signal from received light by using light; and
an optical device that attenuates the light in the optical receiver, wherein
the optical device includes:
a rib optical waveguide including N parallel waveguides connected to outputs of a split coupler of 1 input×N outputs; and
a first electrode and a second electrode that are connected to the rib optical waveguide, and
the rib optical waveguide includes:
a non-conductive slab region formed between the waveguides;
a P doped region that is formed in a first slab region outside one of outermost waveguides of the N waveguides and is connected to the first electrode; and
an N-doped region that is formed in a second slab region outside the other one of the outermost waveguides of the N waveguides and is connected to the second electrode.
